(19) United States
(12) Patent Application Publication
(10) Pub. No.: US 2017/0199838 A1
(43) Pub. Date: Jul. 13, 2017

(54) COMMUNICATION INTERFACE CIRCUIT AND SEMICONDUCTOR INTEGRATED CIRCUIT

(71) Applicant: Renesas Electronics Corporation, Tokyo (JP)

(72) Inventor: Haruki IMANAKA, Tokyo (JP)

(73) Assignee: Renesas Electronics Corporation, Tokyo (JP)

(21) Appl. No.: 15/402,384

(22) Filed: Jan. 10, 2017

(30) Foreign Application Priority Data
Jan. 13, 2016 (JP) 2016-004293

(51) Int. Cl. G06F 13/42

(52) U.S. Cl. CPC G06F 13/4243

(57) ABSTRACT

A communication interface circuit has an input/output buffer driving a clock line (SCL) and receiving the signal level of SCL as an input clock signal, and a clock signal generation circuit. The clock signal generation circuit generates an output clock signal (SCL_O) which repeats the high level of a predetermined high period and the low level of a predetermined low period to drive SCL, measures time since SCL_O is raised until rise of SCL according to the rise is detected as rise time (Tr), and measures time after SCL_O is decreased until fall of SCL according to the decrease is detected as fall time (Tf). The high period and the low period are corrected on the basis of the measured Tr and Tf, respectively.

### CROSS-REFERENCE TO RELATED APPLICATIONS

The disclosure of Japanese Patent Application No. 2016-004293 filed on Jan. 13, 2016 including the specification, drawings and abstract is incorporated herein by reference in its entirety.

### BACKGROUND

The present invention relates to a communication interface circuit and a semiconductor integrated circuit and, more specifically, can be preferably used for a communication interface circuit performing serial communication of a clock synchronous type and a semiconductor integrated circuit on which the communication interface circuit is mounted.

For communication between LSIs (Large Scale Integrated-circuit), serial communication of a clock synchronous type such as an I2C (Inter-Integrated Circuit) is widely used. An I2C bus is comprised of two signal lines of clock SCL and data SDA, and the signal line pulled up is driven by an open-drain system or an open-collector system.

Patent literature 1 discloses a clock signal output circuit capable of correcting duty of a synchronous clock signal in correspondence with increase/decrease of communication nodes. An input low width counter monitoring a clock signal line SCL and counting a low period is provided on the master side. By comparison with an expectation value set in a duty setting register, the duty of a baud rate generator is corrected.

Patent literature 2 discloses a clock line drive circuit capable of preventing decrease of a clock rate due to load capacity of a line. A clock generation counter is provided which counts each of rise time and fall time of a clock, makes a high-level clock output during rise time is counted, and makes a low-level clock output during fall time is counted. In a single master operation, by stopping a clock rise synchronization function, decrease in the clock rate is prevented. At the time of a multi master, by stopping the clock rise synchronization function for a predetermined period, decrease in the clock rate is prevented.

### RELATED ART LITERATURE

### Patent Literature

Patent Literature 1: Japanese Unexamined Patent Application Publication No. 2013-143683
Patent Literature 2: Japanese Unexamined Patent Application Publication No. 2004-310673

### SUMMARY

The inventors of the present invention examined the patent literatures 1 and 2 and found there are the following new problems.

By the circuit disclosed in the patent literature 1, even when the waveform of a clock becomes dull due to fluctuations in the characteristics of the wiring load and the drive circuit, the duty of a clock signal can be corrected. However, also when one of rise time and fall time of the clock becomes long, the duty is corrected to predetermined duty. As a result, the frequency of the clock decreases, and the data transfer rate decreases.

On the other hand, by using the circuit disclosed in the patent literature 2, decrease of the clock rate accompanying the fluctuation in the load capacity can be prevented. In the technique disclosed in the literature, fall synchronization is executed on pre-condition that fall time is not influenced by the load capacity (paragraph 0050). However, the fall time changes due to various factors in reality and exerts influence on the clock rate. Consequently, the situation that decrease of the clock rate can be prevented is limited, so that the fundamental problem is not solved.

Means for solving such problems will be described hereinafter. The other problems and novel features will become apparent from the description of the specification and appended drawings.

An embodiment of the present invention is as follows.

An embodiment relates to a communication interface circuit having an input/output buffer driving a clock line of a clock synchronous communication bus and receiving a signal level of the clock line as an input clock signal, and a clock control circuit, and configured as follows.

The clock control circuit generates an output clock signal which repeats the high level of a predetermined high period and the low level of a predetermined low period, and drives the clock line by the input/output buffer. The clock control circuit measures, as rise time, time since the output clock signal is raised until corresponding rise of the signal of the clock line is detected by the rise of the input clock signal and measures, as fall time, time since the output clock signal is decreased until the corresponding fall of the signal of the clock line is detected by the fall of the input clock signal.

A processor coupled to the clock control circuit corrects the high period and the low period on the basis of the measured rise time and the measured fall time, respectively and supplies the corrected high and low periods to the clock control circuit. Alternatively, an arithmetic circuit is mounted on the clock control circuit itself, calculates correction values for the high period and the low period on the basis of the rise time and the fall time measured, and corrects the high period and the low period.

An effect obtained by the embodiment will be briefly described as follows.

Even when the waveform of a clock becomes dull due to fluctuations of the characteristics of a wiring load and a drive circuit, the communication speed can be corrected accordingly, and the fluctuations can be suppressed.

### BRIEF DESCRIPTION OF THE DRAWINGS

FIG. 1 is a block diagram illustrating the configuration of a communication interface of a comparative example.

FIG. 2 is a block diagram illustrating a configuration example of a communication interface circuit of a first embodiment.

FIG. 3 is a block diagram illustrating a configuration example of a Tr/Tf measurement circuit.

FIG. 4 is a timing chart illustrating an operation example before correction of the communication interface circuit.

FIG. 5 is a timing chart illustrating an operation example after correction of the communication interface circuit.

FIG. 6 is a block diagram illustrating a connection example by a clock synchronous bus between an LSI (MCU) on which a communication interface (I2C bus interface) circuit is mounted and devices of other communication partners.

FIG. 7 is a block diagram illustrating a configuration example of a communication interface circuit of a second embodiment.

FIG. 8 is a block diagram illustrating a configuration example of a communication interface circuit of a third embodiment.

FIG. 9 is a flowchart illustrating an operation example of the communication interface circuit of the third embodiment.

### DETAILED DESCRIPTION

Embodiments will be described in detail. In all of the drawings for explaining modes for carrying out the present invention, the same reference numerals are designated to components having the same function and repetitive description will not be given.

### First Embodiment

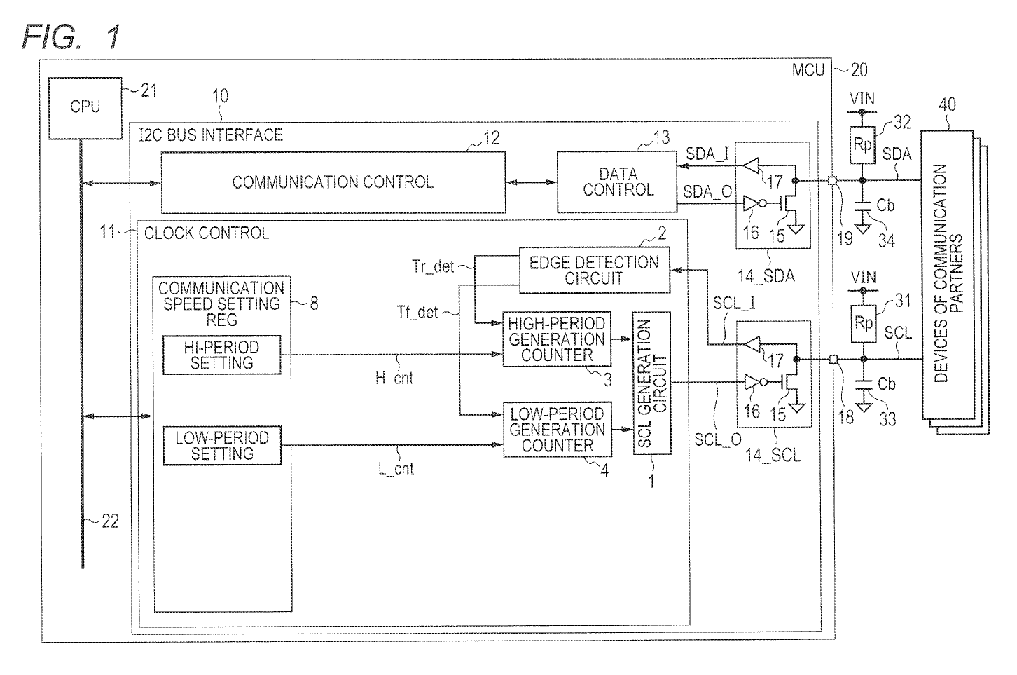

FIG. 1 is a block diagram illustrating the configuration of a communication interface circuit 10 of a comparative example which is assumed as a simple configuration to clarify problems of the conventional technique at the time of examination by the inventors of the present invention. The communication interface circuit 10 is, for example, an I2C bus interface, mounted as an integrated circuit on an MCU (Micro-Controller Unit) 20 as an example of an LSI, and coupled to one or plural devices 40 of communication partners via two lines of a clock line SCL and a data line SDA. As long as particularly explained in the specification, the lines in the diagram are mounted as arbitrary number of signal lines. In this diagram and the other diagrams, the number is not discriminated between one and plural number and so-called vector notation is not employed.

The clock line SCL and the data line SDA are coupled to predetermined voltage level VIN by pull-up resistors (Rp) 31 and 32, respectively, and driven by an open-drain or open-collector transistor. Capacitors (Cb) 33 and 34 illustrated in the diagram are capacitors that total of wiring capacity and load capacities by devices coupled to a communication bus such as the devices 40 of communication partners is schematically expressed by a lumped constant. The clock line SCL and the data line SDA shift to the low level by being driven by the open-drain or open-collector transistor and, when the drive is stopped, shift to the high level by being charged to the predetermined voltage level VIN through the pull-up resistors (Rp) 31 and 32. The low level is, for example, ground potential (0V) and the predetermined voltage level VIN is set to a voltage level satisfying the specifications of the communication bus such as 5V, 3.3V, or 3V using the ground potential as the reference.

The communication interface circuit (I2C bus interface) 10 is coupled to each of the clock line SCL and the data line SDA via terminals 18 and 19, respectively, of the MCU 20 and coupled to a CPU (Central Processing Unit) 21 via an internal bus 22 in the MCU 20. The communication interface circuit 10 has an I/O buffer for SCL (14_SCL) and an I/O buffer for SDA (14_SDA) coupled to the terminals 18 and 19, respectively, a communication control circuit 12 and a data control circuit 13 coupled to the internal bus 22, and a clock control circuit 11 having a communication speed setting register 8 which is coupled to the internal bus 22 and can be accessed from the CPU 21.

Each of the I/O buffer for SDA (14_SDA) and the I/O buffer for SCL (14_SCL) is comprised of an open-drain MOSFET 15, an inverter 16, and an input buffer 17.

The I/O buffer for SDA (14_SDA) drives the data line SDA via the terminal 19 on the basis of an output data signal SDA_O supplied from the data control circuit 13, and supplies an input from the data line SDA as an input data signal SDA_I to the data control circuit 13 via the buffer 17 in the I/O buffer for SDA (14_SDA). In the period that the output data signal SDA_O is at the low level, the data line SDA of the communication bus is driven at the low level. In the period that the output data signal SDA_O is at the high level, the data line SDA is open. When the data line SDA is open, it is charged toward VIN via the pull-up resistor (Rp) 32 and shifts to the high level. At the time of data reception, the data control circuit 13 sets the output data signal SDA_O to the high level and opens the data line SDA. The signal level of the data line SDA which is driven/controlled by the device 40 of the communication partner is detected by the input buffer 17 and supplied as the input data signal SDA_I to the data control circuit 13.

The I/O buffer for SCL (14_SCL) drives the clock line SCL via the terminal 18 on the basis of an output clock signal SCL_O supplied from the clock control circuit 11, and supplies a potential state of the clock line SCL as an input data signal SCL_I to the clock control circuit 11 via the buffer 17 in the I/O buffer for SCL (14_SCL). In the period that the output clock signal SCL_O is at the low level, the clock line SCL of the communication bus is driven at the low level. In the period that the output clock signal SCL_O is at the high level, the clock line SCL is open. When the clock line SCL is open, it is charged toward VIN via the pull-up resistor (Rp) 31 and shifts to the high level. The I/O buffer for SCL (14_SCL) supplies the voltage level of the clock line SCL driven by itself as an input clock signal SCL_I to the clock control circuit 11 by the buffer 17.

The clock control circuit 11 has, in addition to the communication speed setting register 8, a clock (SCL) generation circuit 1, an edge detection circuit 2, a high-period generation counter 3, and a low-period generation counter 4.

When the MCU 20 functions as a master of communication, the communication interface circuit 10 makes the clock control circuit 11 and the I/O buffer for SCL (14_SCL) operate to output a clock signal to the clock line SCL, and makes the communication control circuit 12, the data control circuit 13, and the I/O buffer for SDA (14_SDA) operate to transmit/receive data synchronously with the clock signal output to the clock line SCL. At this time, the CPU 21 writes a high-period setting value and a low-period setting value of the clock line SCL into the communication speed setting register 8 in order to designate the communication speed. The high-period setting value and the low-period setting value which are set are supplied as a high-period setting value H_cnt and a low-period setting value L_cnt to the high-period generation counter 3 and the low-period generation counter 4, respectively. On the basis of the high-period setting value and the low-period setting value which are set, the SCL generation circuit 1 supplies the output clock signal SCL_O to the I/O buffer for SCL (14_SCL), and the I/O buffer for SCL (14_SCL) drives the clock line SCL in the communication bus.

To the edge detection circuit 2, the input clock signal SCL_I is supplied. The edge detection circuit 2 detects the rising edge of the voltage level of the clock line SCL, supplies it as a rising-edge detection signal Tr_det to the high-period generation counter 3, detects the trailing edge of the voltage level of the clock line SCL, and supplies it as a trailing-edge detection signal Tf-det to the low-period generation counter 4. The high-period generation counter 3 starts counting operation at the time point that the rising-edge detection signal Tr_det is input, sets the output clock signal SCL_O to the high level to make the clock line SCL in the high period until the high-period setting value H_cnt supplied from the communication speed setting register 8, and supplies the signal to the clock generation circuit 1. The low-period generation counter 4 starts the counting operation at the time point the trailing-edge detection signal Tf_det is input, sets the output clock signal SCL_O to the low level to make the clock line SCL in the low period until the low-period setting value L_cnt which is supplied from the communication speed setting register 8, and supplies the signal to the clock generation circuit 1.

The clock control circuit 11 of the I2C bus interface generates the high period and the low period of the clock line SCL basically by the high-period generation counter 3 and the low-period generation counter 4.

In the protocol of the I2C bus interface, the device 40 of the communication partner as a slave can make the master device temporarily stop communication (transmission of clocks) by operating the clock line SCL. Consequently, the I2C bus interface 10 of the MCU 20 monitors an input clock signal SCL_I as a feedback from the clock line SCL, does not make the high-period generation counter 3 operate until the clock line SCL actually rises, and does not make the low-period generation counter 4 operate until the clock line SCL actually trails.

The protocol of the I2C bus interface includes an SCL synchronization specification at the time of multiple master. Operation has to be performed while monitoring the operation of the device of the communication partner. Therefore, the high period has to be counted from the rising of the clock line SCL and the low period has to be counted from the trailing. Consequently, when the clock line SCL is monitored, the communication cycle does not match the total value of the high-count value and the low-count value and, further, rise time Tr and fall time Tf are added. Since Tr and Tf change according to the load of the clock line SCL and the characteristics of the I/O buffer for SCL (14_SCL), there is the possibility that the communication speed does not become expected one.

The rise time Tr is determined depending on the values of a capacitor Cb and the pull-up resistor (Rp) 31, and the fall time Tf is determined depending on the capacitor Cb and the current drive capability of the MOSFET 15 of the I/O buffer for SCL (14_SCL). The user of the MCU 20 obtains the capacitor Cb in a mounting state in which all of the devices 40 of communication partners are coupled and the value of the pull-up resistor 31 is determined by a design value, simulation, or measurement of an actual device and calculates expectation values (prediction values) of the rise time Tr and the fall time Tf. The user of the MCU 20 preliminarily adjusts and sets a high-period setting value and a low-period setting value by using the calculated expectation values of the rise time Tr and the fall time Tf so that desired communication speed can be obtained.

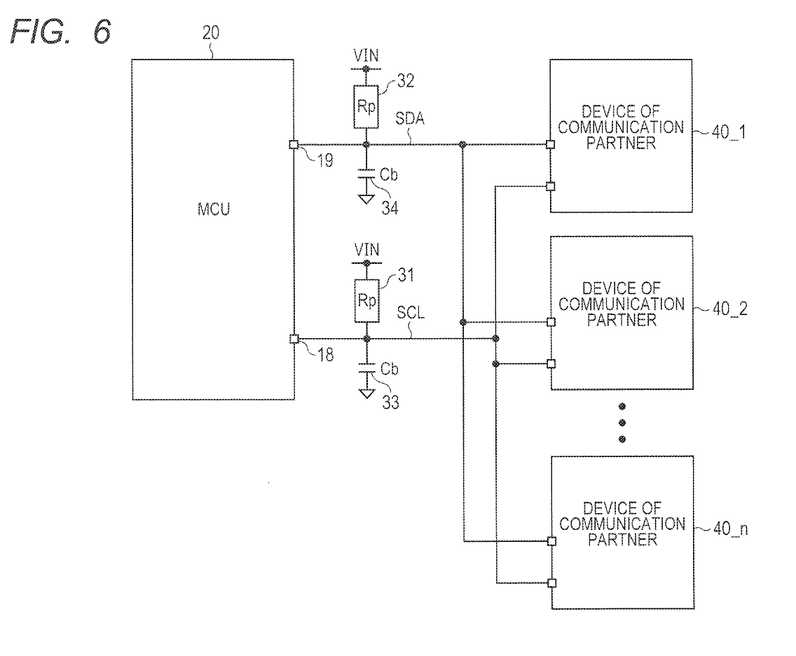

FIG. 6 is a block diagram illustrating a connection example by a clock synchronous bus between the LSI (MCU) 20 on which the communication interface circuit 10 is mounted and the devices 40_1 to 40_n of other communication partners. The clock SCL and the data SDA as components of the communication bus are coupled to the terminals 18 and 19 of the MCU 20 and also coupled to “n” pieces of devices 40_1 to 40_n of other communication partners. The clock SCL and the data SDA is pulled up to VIN by the pull-up resistors Rp 31 and 32 and its load capacitances are representatively illustrated as capacitances Cb 33 and 34. When mounting states such as the kinds and numbers of the devices 40_1 to 40_n of communication partners and line paths of the clock SCL and the data SDA are determined, the load capacitances Cb 33 and 34 can be obtained by simulation, actual measurement, or the like. Consequently, the high-period setting value and the low-period setting value can be preliminarily adjusted and set within the range of precision to some degree. However, fluctuation due to manufacture variations of the current drive capability of the MOSFET 15 of the I/O buffer for SCL (14_SCL) and fluctuation due to changes in the power supply voltage are not always within the range of allowable precision. Further, for example, in a system such that an electronic substrate coupled to a communication bus can be detachably attached by a connector or the like, there is the case that the wiring load changes by the attachment/detachment and the numbers and kinds of devices of communication partners change.

In such a case, it is necessary to newly obtain expectation values of the rise time Tr and the fall time Tf by actual measurement or the like, adjust the high-period setting value and the low-period setting value again, and re-set the values. Further, since the fall time Tf is determined depending on the current drive capability of the MOSFET 15 of the I/O buffer (14_SCL) for SCL as described above, it is influenced by the manufacture variations of the MOSFET 15 and fluctuations in the power supply voltage and operation temperature.

It was found that the fluctuations and variations in the rise time Tr and the fall time Tf are recognized as an error between set communication speed and actual communication speed by the user and there is a case that the existent of such an error is not allowed in some systems.

To solve such a problem, the clock control circuit 11 can employ the following configuration. That is, the clock control circuit 11 drives the clock line SCL of the clock synchronous communication bus in the bus interface circuit 10, is coupled to the I/O buffer 14_SCL which receives the signal level of the clock line SCL as the input clock signal SCL_I, and operates as follows. The clock control circuit 11 generates the output clock signal SCL_O which repeats the high level of a predetermined high period and the low level of a predetermined low period and drives the clock line SCL by the I/O buffer 14_SCL.

The clock control circuit 11 increases the output clock signal SCL_O from the low level to the high level and measures time until the rising edge of the clock line SCL according to the rise is detected by the rising edge of the input clock signal SCL_I as the rise time Tr. Similarly, the clock control circuit 11 measures, as the fall time Tr, time since the output clock signal SCL_O is decreased from the high level to the low level until the falling edge of the clock line SCL according to the decrease is detected. On the basis of the rise time Tr and the fall time Tf measured, the high period and the low period are corrected. The high period and the low period may be automatically performed by providing an arithmetic circuit in the clock control circuit 11 or may be performed by, for example, executing software by a processor similar to the CPU 21 illustrated in FIG. 1, which is externally attached to the clock control circuit 11. A mode of executing a correction by software will be specifically described in a third embodiment.

Consequently, even when the waveform of the clock becomes dull due to the fluctuation of the characteristics of the wiring load and the drive circuit, the communication speed can be corrected accordingly and the fluctuations can be suppressed.

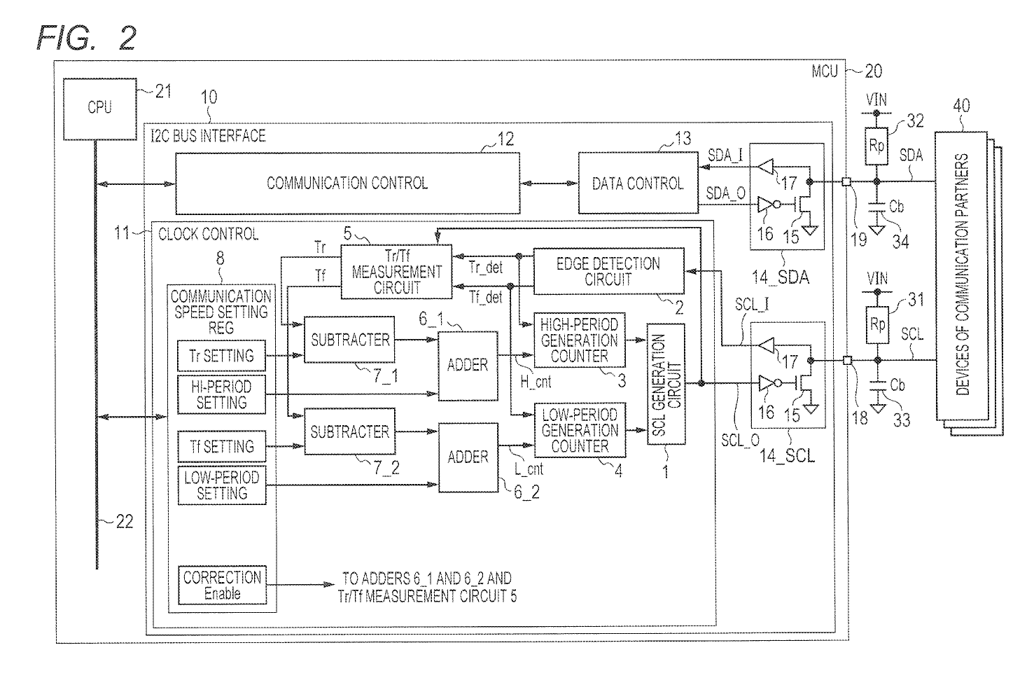

FIG. 2 is a block diagram illustrating a configuration example of the communication interface circuit 10 of the first embodiment. The communication interface circuit 10 is, for example, an I2C bus interface and mounted as an integrated circuit on the MCU 20 as an example of an LSI and coupled to one or plural devices 40 of communication partners by the two lines of the clock line SCL and the data line SDA. In the communication interface circuit 10 of the first embodiment, an arithmetic circuit is provided in the clock control circuit 11, and the high period and the low period are corrected automatically.

The clock line SCL and the data line SDA are coupled to the predetermined voltage level VIN via the pull-up resistors (Rp) 31 and 32, respectively and driven by an open-drain or open-collector transistor. The capacitances (Cb) 33 and 34 illustrated in the diagram are capacitances that total of the wiring capacity and the load capacities by devices coupled to the communication bus such as the devices 40 of communication partners is schematically expressed by a lumped constant. As the configuration of the communication bus including the devices 40 of communication partners is similar to that of FIG. 1, more specific description will not be given here.

The communication interface circuit 10 is coupled to each of the clock line SCL and the data line SDA via terminals 18 and 19, respectively, of the MCU 20 and coupled to the CPU 21 via the internal bus 22 in the MCU 20. The communication interface circuit 10 has the I/O buffer for SCL (14_SCL) and the I/O buffer for SDA (14_SDA) coupled to the terminals 18 and 19, respectively, the communication control circuit 12 and the data control circuit 13 coupled to the internal bus 22, and the clock control circuit 11 having the communication speed setting register 8 which is coupled to the internal bus 22 and can be accessed from the CPU 21. Since the configuration of the I/O buffer for SDA (14_SDA) and the I/O buffer for SCL (14_SCL) and the coupling and function of the input data signal SDA_I, the output data signal SDA_O, the input clock signal SCL_I, and the output clock signal SCL_O as internal signals are similar to those in the comparative example described with reference to FIG. 1, the detailed description will not be repeated here.

In a manner similar to the comparative example illustrated in FIG. 1, the clock control circuit 11 has, in addition to the clock (SCL) generation circuit 1, the edge detection circuit 2, the high-period generation counter 3, the low-period generation counter 4, and the communication speed setting register 8, a rise/fall (Tr/Tf) measurement circuit 5 and adders 6_1 and 6_2 and subtracters 7_1 and 7_2 as arithmetic circuits for correction. In the comparative example, only the high-period setting value and the low-period setting value are written in the communication speed setting register 8. In the first embodiment, in addition to the high-period setting value and the low-period setting value, a rise time (Tr) setting value, a fall time (Tf) setting value, and a correction enable as control data permitting correction of the high period and the low period are stored.

To the edge detection circuit 2, the input clock signal SCL_I is supplied. The edge detection circuit 2 detects the rising edge of the voltage level of the clock line SCL, supplies it as the rising-edge detection signal Tr_det to the high-period generation counter 3, detects the trailing edge of the voltage level of the clock line SCL, and supplies it as the trailing-edge detection signal Tf-det to the low-period generation counter 4. The rising-edge detection signal Tr_det and the trailing-edge detection signal Tf_det as outputs of the edge detection circuit 2 are supplied also to the Tr/Tf measurement circuit 5.

To the Tr/Tf measurement circuit 5, the rising-edge detection signal Tr_det and the trailing-edge detection signal Tf_det are input from the edge detection circuit 2 and the output clock signal SCL_O is input from the I/O buffer (14_SCL) for SCL. The Tr/Tf measurement circuit 5 obtains the rise time Tr and the fall time Tf on the basis of those signals and supplies them to the subtracters 7_1 and 7_2, respectively. The subtracter 7_1 obtains the difference (Tr correction value) between the input rise time Tr and the Tr setting value which is set in the communication speed setting register 8 and inputs it to the adder 6_1. The adder 6_1 adds the input difference (Tr correction value) and the high-period setting value which is set in the communication speed setting register 8 to obtain the high period H_cnt and supplies the high period H_cnt to the high-period generation counter 3. The subtracter 7_2 obtains the difference (Tf correction value) between the input fall time Tf and the Tf setting value which is set in the communication speed setting register 8 and inputs it to the adder 6_2. The adder 6_2 adds the input difference (Tf correction value) and the low-period setting value which is set in the communication speed setting register 8 to obtain the low period L_cnt and supplies the low period L_cnt to the low-period generation counter 4.

Correction of the high period H_cnt and the low period L_cnt is executed only in the period that the correction enable is set in the communication speed setting register 8. The correction enable is input as a control signal (enable signal), for example, to the adders 6_1 and 6_2 and the Tr/Tf measurement circuit 5 and stops the operation of those circuits in the period where correction is not executed. The details of the correction enable will be described later.

The high-period generation counter 3 starts counting operation at the time point the rising-edge detection signal Tr_det is input, sets the output clock signal SCL_O to the high level to make the clock line SCL in the high period until the high-period setting value which is stored in the communication speed setting register 8 becomes the high-count value H_cnt corrected by the Tr correction value, and supplies the signal to the clock generation circuit 1. The low-period generation counter 4 starts the counting operation at the time point the trailing-edge detection signal Tf_det is input, sets the output clock signal SCL_O to the low level to make the clock line SCL in the low period until the high-period setting value which is stored in the communication speed setting register 8 becomes the low-count value L_cnt corrected by the Tr correction value, and supplies the signal to the clock generation circuit 1.

The SCL generation circuit 1 supplies the output clock signal SCL_O to the I/O buffer for SCL (14_SCL) on the basis of the high-count value and the low-count value which are corrected, and the I/O buffer for SCL (14_SCL) drives the clock line SCL of the communication bus.

The user sets parameters of expected operation of the communication interface (I2C bus interface) circuit 10 by writing the Tr setting value, the high-period setting value, the Tf setting value, and the low-period setting value into the communication speed setting register 8 from the CPU 21 via the internal bus 22.

The clock control circuit 11 measures the phase difference between the input clock signal SCL_I and the output clock signal SCL_O by the Tr/Tf measurement circuit 5 and sets it as a Tr measurement value/Tf measurement value. The measured Tr measurement value/Tf measurement value is compared with the Tr setting value/Tf setting value as an expectation value, and the difference is set as a Tr correction value/Tf correction value and added to the high-period setting value/low-period setting value. Consequently, the result of the correction is reflected in the high-period count value (H_cnt)/low-period count value (L_cnt), a deviation from the Tr/Tf expectation value is corrected, and desired communication speed is realized. When the measured Tr measurement value is larger than the Tr setting value as an expectation value, the high-period count value (H_cnt) operates in the decreasing direction. When the measured Tr measurement value is smaller than the Tr setting value, the high-period count value (H_cnt) operates in the increasing direction.

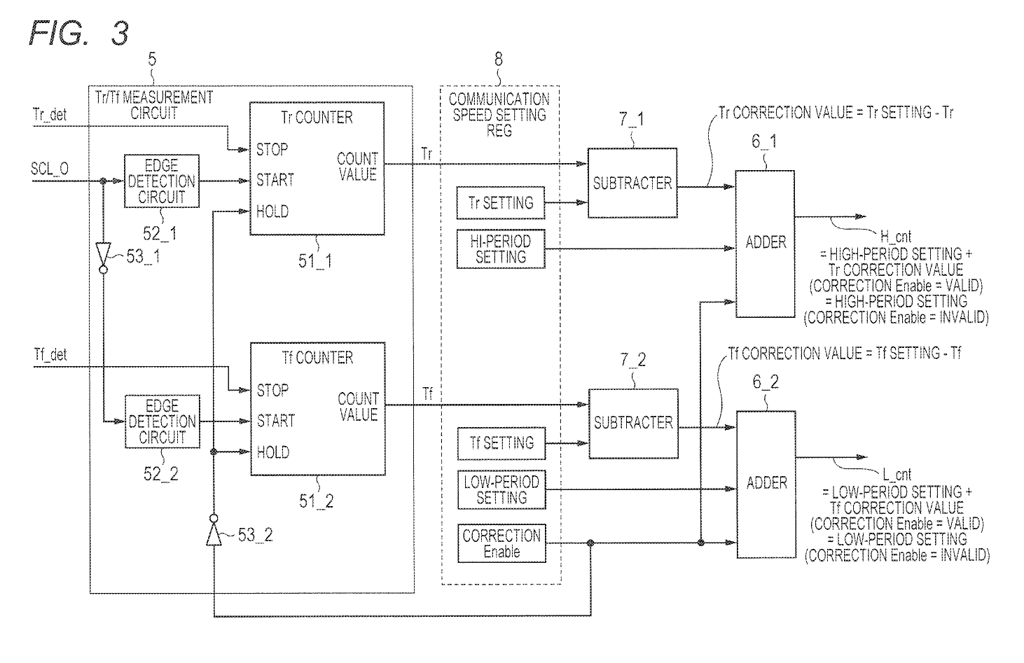

FIG. 3 is a block diagram illustrating a configuration example of the Tr/Tf measurement circuit 5 and also illustrating arithmetic circuits for correction which are coupled at the post stage of the Tr/Tf measurement circuit 5. The Tr/Tf measurement circuit 5 has a rise time (Tr) counter 51_1 and a fall time (Tf) counter 51_2, edge detection circuits 52_1 and 52_2, and inverters 53_1 and 53_2. The Tr counter 51_1 starts counting at the rising of the output clock signal SCL_O and stops the counting at the rising of the input clock signal SCL_I, thereby outputting the count value as the rise time Tr. The Tf counter 51_2 starts the counting at the falling of the output clock signal SCL_O and stops the counting at the falling of the input clock signal SCL_I, thereby outputting the count value as the fall time Tf.

The rising edge of the output clock signal SCL_O which is input is detected by the edge detection circuit 52_1, supplied to a start terminal of the Tr counter 51_1, the falling edge of the output clock signal SCL_O is detected by the inverter 53_1 and the edge detection circuit 52_2, and supplied to a start terminal of the Tf counter 51_2.

The rising-edge detection signal Tr-det is input to a stop terminal of the Tr counter 51_1, and an inversion signal by the inverter 53_2 of the correction enable held in the communication speed setting register 8 is input to a hold terminal. When the correction enable is valid, the counting operation is stopped, and a count value just before the stop is held. The count value is a value of the measured rise time (Tr) and supplied to the subtracter 7_1. The trailing-edge detection signal Tf-det is input to a stop terminal of the Tf counter 51_2, and an inversion signal by the inverter 53_2 of the correction enable held in the communication speed setting register 8 is input to a hold terminal like in the Tr counter 51_1. When the correction enable is valid, the counting operation is stopped, and a count value just before the stop is held. The count value is a value of the measured fall time (Tf) and supplied to the subtracter 7_2.

The subtracter 7_1 calculates the difference between the Tr setting value stored in the communication speed setting register 8 and the measured rise time (Tr) as the Tr correction value, and the subtracter 7_2 calculates the difference between the Tf setting value stored in the communication speed setting register 8 and the measured fall time (Tf) as the Tf correction value. That is, the subtracter 7_1 calculates

Tr correction value=Tr setting value−rise time (Tr), and

the subtracter 7_2 calculates

Tf correction value=Tf setting value−fall time (Tf).

When the rise time (Tr) as a measurement value is larger than the Tr setting value as an expectation value, the Tr correction value becomes a negative value. Similarly, when the fall time (Tf) is larger than the Tf setting value, the Tf correction value becomes a negative value.

The Tr correction value and the Tf correction value are input to the adders 6_1 and 6_2, respectively. The adder 6_1 outputs the sum of the high-period setting value stored in the communication speed setting register 8 and the Tr correction value as a high count value (H_cnt) to the high-period generation counter 3, and the adder 6_2 outputs the sum of the low-period setting value and the Tf correction value as a low count value (L_cnt) to the low-period generation counter 4. That is, the adders 6_1 and 6_2 calculate

High-count value (H_cnt)=high-period setting value+Tr correction value and

Low-count value (L_cnt)=low-period setting value+Tf correction value, respectively.

The adders 6_1 and 6_2 execute the above-described correction computation only when the correction enable is valid and, when the correction enable is invalid, output the high-period setting value and the low-period setting value as they are. That is, the adder 6_1 outputs the high count value (H_cnt)=high-period setting value, and the adder 6_2 outputs the low count value (L_cnt)=low-period setting value.

When the Tr correction value is positive, the Tr setting value is larger than actual Tr, so that the high count value (H_cnt) becomes larger than the high-period setting value.

When the Tr correction value is negative, the Tr setting value is smaller than actual Tr, so that the high count value (H_cnt) becomes smaller than the high-period setting value. In such a manner, the difference between the Tr setting value and actual Tr is cancelled off. The sum of the actual Tr and the high count value (H_cnt) is corrected to become equal to “high-period setting value+Tr setting value”. With respect to Tf, similarly, the difference between the Tf setting value and the actual Tf is cancelled off, and the sum of the actual Tf and the low count value (L_cnt) is corrected to become equal to “low-period setting value+Tf setting value”. Consequently, correction is made so that the sum of the Tr measurement value, the high count value (H_cnt), the Tf measurement value, and the low count value (L_cnt) as an actual cycle of the clock SCL corresponding to the communication speed matches the sum of the Tr setting value, the high-period setting value, the Tf setting value, and the low-period setting value as desired communication speed.

Since it is necessary to measure Tr and Tf at least once in order to correct the communication speed, dummy communication or the like is executed in a state where the correction enable is made invalid and Tr and Tf are measured. After that, by making the correction enable valid, desired communication speed is realized.

The operation of the communication interface circuit 10 of the first embodiment will be described more specifically.

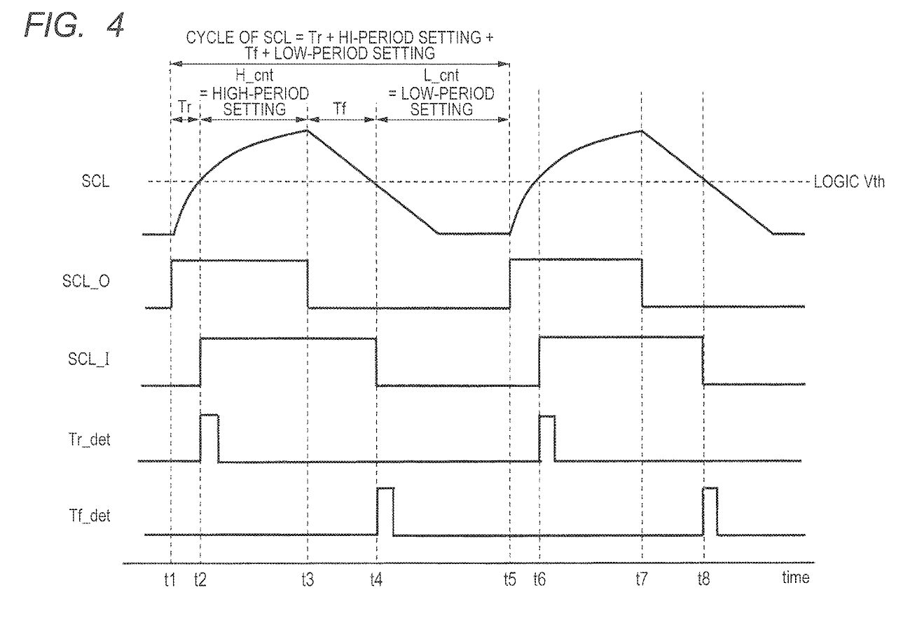

FIG. 4 is a timing chart illustrating an operation example before correction of the communication interface circuit 10 (correction enable is invalid). The horizontal axis indicates time and, in the vertical axis direction, waves of the clock SCL of the communication bus, the output clock signal SCL_O, the input clock signal SCL_I, the rising-edge detection signal Tr_det, and the trailing-edge detection signal Tf_det are schematically illustrated in order from the top. To facilitate understanding, the rise time and the fall time of the clock SCL are drawn exaggeratingly, and there is no absolute and relative precision in the time axis.

Before time t1, the output clock signal SCL_O is at the low level and the clock SCL is driven to the low level by the MOSFET 15 of the I/O buffer for SCL (14_SCL).

When the output clock signal SCL_O shifts to the high level at the time t1, the MOSFET 15 is turned off, the clock SCL is opened, and the capacitor Cb is charged by the pull-up resistor (Rp) 31, so that the potential of the clock line SCL gradually increases. At time t2, when the potential of the clock line SCL exceeds a logic threshold (Vth) of the buffer 17 of the I/O buffer for SCL (14_SCL), the input clock signal SCL_I shifts to the high level, the rising edge of the input clock signal SCL_I is detected by the edge detection circuit 2, and the rising-edge detection signal Tr_det is output. The high-period generation counter 3 starts counting operation from the time t2 at which the rising-edge detection signal Tr_det is input. At time t3 when the count value reaches the high-period setting value H_cnt supplied from the communication speed setting register 8, the output clock signal SCL_O is changed to the low level by the SCL generation circuit 1.

In parallel with the above operation, the Tr counter 51_1 (FIG. 3) counts a period from the time t1 when the output clock signal SCL_O rises to the time t2 when the rising-edge detection signal Tr_det is input to the stop terminal and outputs it as the rise time Tr. Since the correction enable is invalid, the high count value H_cnt is not corrected but is maintained at the high-period setting value.

When the output clock signal SCL_O shifts to the low level, the MOSFET 15 in the I/O buffer for SCL (14_SCL) is turned on and drives the clock line SCL to the low level. The fall of the clock line SCL at this time is determined by the capacitance of the capacitor Cb and the current drive capability of the MOSFET 15. At time t4 when the clock SCL becomes below the logic threshold of the buffer 17, the input clock signal SCL_I shifts to the low level, its trailing edge is detected by the edge detection circuit 2, and the trailing-edge detection signal Tf_det is output. The low-period generation counter 4 starts counting operation from the time t4 when the trailing-edge detection signal Tf_det is input. At time t5 when the count value reaches the low-period setting value L_cnt supplied from the communication speed setting register 8, the output clock signal SCL_O is shifted to the high level by the SCL generation circuit 1.

In parallel with the above operation, the Tf counter 51_2 (FIG. 3) counts a period from the time t3 when the output clock signal SCL_O falls to the time t4 when the trailing-edge detection signal Tf_det is input to the stop terminal and outputs it as the fall time Tr. Since the correction enable is invalid, the low count value L_cnt is not corrected but is maintained at the low-period setting value.

When the output clock signal SCL_O shifts to the high level, the same operations as those from the time t1 to the time t5 are repeated.

In the operation before the correction (the correction enable is invalid) of the communication interface circuit 10, the cycle of the clock SCL is a value obtained by adding the rise time Tr and the fall time Tf to the high-period setting value and the low-period setting value, respectively. The rise time TR is time from the time t1 when the output clock signal SCL_O rises to the time t2 when the clock signal SCL on the bus actually shifts to the high level, exceeds the logic threshold (Vth), and is detected as the rise of the input clock signal SCL_I. The fall time Tf is time from the time t3 when the output clock signal SCL_O falls to the time t4 when the clock signal SCL on the bus actually shifts to the low level, becomes below the logic threshold (Vth), and is detected as the fall of the input clock signal SCL_I.

The difference between the actual rise time Tr and the Tr setting value and the difference between the actual fall time Tf and the Tf setting time appear as differences between actual communication speeds and desired communication speeds. In the timing chart at this stage, the operations are the same as those in the comparative example illustrated in FIG. 1 (not illustrated in the timing chart).

In the first embodiment, at this stage, the actual rise time Tr and fall time Tf are measured and held as a Tr measurement value and a Tf measurement value by the Tr/Tf measurement circuit 5. After that, when the correction enable is made valid, the high count value (H_cnt) and the low count value (L_cnt) corrected on the basis of the Tr measurement value and the Tf measurement value are supplied to the high-period generation counter 3 and the low-period generation counter 4, respectively, and communication speed is corrected.

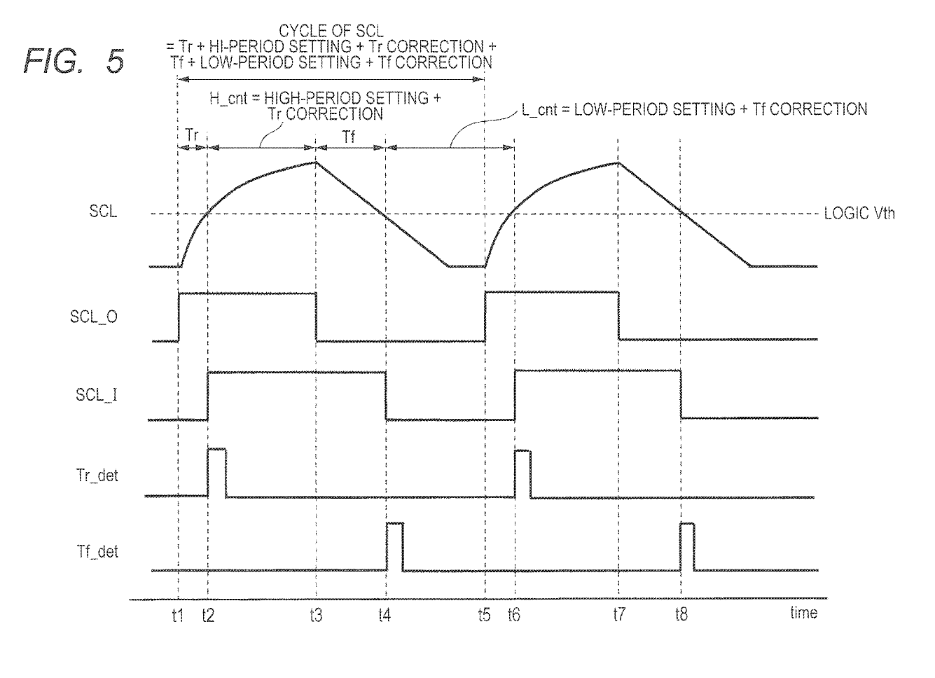

FIG. 5 is a timing chart illustrating an operation example after correction (the correction enable is valid). Like FIG. 4, the horizontal axis indicates time and, in the vertical axis direction, waves of the clock SCL of the communication bus, the output clock signal SCL_O, the input clock signal SCL_I, the rising-edge detection signal Tr_det, and the trailing-edge detection signal Tf_det are schematically illustrated in order from the top. To facilitate understanding, the rise time and the fall time of the clock SCL are drawn exaggeratingly, and there is no absolute and relative precision in the time axis like in FIG. 4.

Before time t1, the output clock signal SCL_O is at the low level and the clock SCL is driven to the low level by the MOSFET 15 of the I/O buffer for SCL (14_SCL).

When the output clock signal SCL_O shifts to the high level at the time t1, the MOSFET 15 is turned off, the clock SCL is opened, and the capacitor Cb is charged by the pull-up resistor (Rp) 31, so that the potential of the clock line SCL gradually increases. At time t2, when the potential of the clock line SCL exceeds the logic threshold (Vth) of the buffer 17 of the I/O buffer for SCL (14_SCL), the input clock signal SCL_I shifts to the high level, the rising edge of the input clock signal SCL_I is detected by the edge detection circuit 2, and the rising-edge detection signal Tr_det is output. Since the correction enable is valid, as described with reference to FIG. 4, correction is made as “high count value H_cnt=high period setting value+Tr correction value” by using the rise time Tr measured by making the correction enable invalid. The high-period generation counter 3 starts counting operation from the time t2 at which the rising-edge detection signal Tr_det is input. At the time t3 when the count value reaches the corrected high count value H_cnt, the output clock signal SCL_O is changed to the low level by the SCL generation circuit 1.

When the output clock signal SCL_O shifts to the low level, the MOSFET 15 in the I/O buffer for SCL (14_SCL) is turned on and drives the clock line SCL to the low level. The fall of the clock line SCL at this time is determined by the capacitance of the capacitor Cb and the current drive capability of the MOSFET 15. At time t4 when the clock SCL becomes below the logic threshold of the buffer 17, the input clock signal SCL_I shifts to the low level, its trailing edge is detected by the edge detection circuit 2, and the trailing-edge detection signal Tf_det is output. Since the correction enable is valid, as described with reference to FIG. 4, correction is made as “low count value L_cnt=low-period setting value+Tf correction value” by using the fall time Tf measured by making the correction enable invalid. The low-period generation counter 4 starts counting operation from the time t4 when the trailing-edge detection signal Tf_det is input. At time t5 when the count value reaches the corrected low count value L_cnt, the output clock signal SCL_O is shifted to the high level by the SCL generation circuit 1.

When the output clock signal SCL_O shifts to the high level, the same operations as those from the time t1 to the time t5 are repeated.

FIG. 5 illustrates an example in which since there is no difference between the measured rise time Tr and the Tr setting value as an expectation value, correction in the high period is not performed, since the measured fall time Tf is larger than the Tf setting value as an expectation value, a negative Tf correction value is added, and the low count value L_cnt is corrected to a value smaller than the low-period setting value.

The cycle of the clock SCL by the operation is a total of the high period as a sum of the rise time Tr, the high-period setting value, and the Tr correction value and the low period as a sum of the fall time Tf, the low-period setting value, and the Tf correction value. As described above, Tr correction value=Tr setting value−Tr. Consequently, the high period of the clock SCL=Tr+high-period setting value+Tr correction value=Tr+high-period setting value+(Tr setting value−Tr)=high-period setting value+Tr setting value. Similarly, Tf correction value=Tf setting value−Tf. Consequently, the low period of the clock SCL=Tf+low-period setting value+Tf correction value=Tf+low-period setting value+(Tf setting value−Tf)=low-period setting value+Tf setting value. Therefore, cycle of clock SCL=high-period setting value+Tr setting value+low-period setting value+Tf setting value. Even in the case where the rise time Tr and the fall time Tf fluctuate from assumed setting values due to fluctuations in the wiring loads such as the pull-up resistor Rp and the capacitor Cb and the characteristics of drive circuits such as the I/O buffer for SCL (14_SCL), the fluctuation is corrected, and the communication speed as set can be obtained.

Also in the case where there is fluctuation due to manufacture variations of the current drive capability of the MOSFET 15 of the I/O buffer for SCL (14_SCL) and fluctuation due to a change in temperature and power supply voltage as described above with reference to FIG. 6, by correcting the fluctuation in the rise time Tr and the fall time Tf caused by the fluctuation with the Tr correction value and the Tf correction value, the communication speed as set can be obtained. Further, for example, in a system such that an electronic substrate coupled to the communication bus can be detachably attached by a connector or the like, even in the case that the wiring load changes by the attachment/detachment and the numbers and kinds of devices of communication partners change, similarly, by correcting the fluctuation in the rise time Tr and the fall time Tf caused by the fluctuation with the Tr correction value and the Tf correction value, the communication speed as set can be obtained.

Such correction may be arranged to be executed only in a specific calibration period by using the correction enable. A period where correction may not be performed correctly by the function of cross stretch or SCL synchronization can be set not in the calibration period. For example, when a substrate coupled to a communication bus by a hot plug is attached/detached immediately after power-on or when coupling of a device of a communication partner is changed, correction may be executed by providing a period dedicated to calibration in which it is assured that cross stretch or SCL synchronization is not performed.

By providing such a correction function, it becomes unnecessary to have a large margin in the value of the pull-up resistor Rp, and power consumption of the communication bus can be reduced. Although the rise/fall time is set by the specifications of the communication bus, to make a design so as to satisfy the specifications of the communication bus in consideration of also the manufacture variations of the MOSFET 15 of the I/O buffer for SCL (14_SCL) and fluctuations due to temperature and power supply voltage, a large margin is necessary for the value of the pull-up resistor Rp, and there is tendency that a smaller resistance value is employed. To prevent a communication error, a signal on the communication bus has to be increased and decreased sufficiently sharply. On the other hand, if rise/fall is too sharp, it may cause an error or noise. However, in many cases, the problem can be avoided by another method such as insertion of a resistive element serially to the communication bus. By setting a relatively small value in the pull-up resistor Rp as described above, breakthrough current when the communication bus is driven by an open-drain or open-collector buffer becomes large, and power consumption increases. In the first embodiment, the fluctuation in Tr/Tf is suppressed by the correction technique, it is unnecessary to provide a large margin for the value of the pull-up resistor Rp, and the value of the pull-up resistor Rp does not have to be made extremely small. Therefore, the magnitude of the flow-through current determined by the value of the pull-up resistor Rp is suppressed, and increase in the power consumption can be suppressed. The above is also in other embodiments.

### Second Embodiment

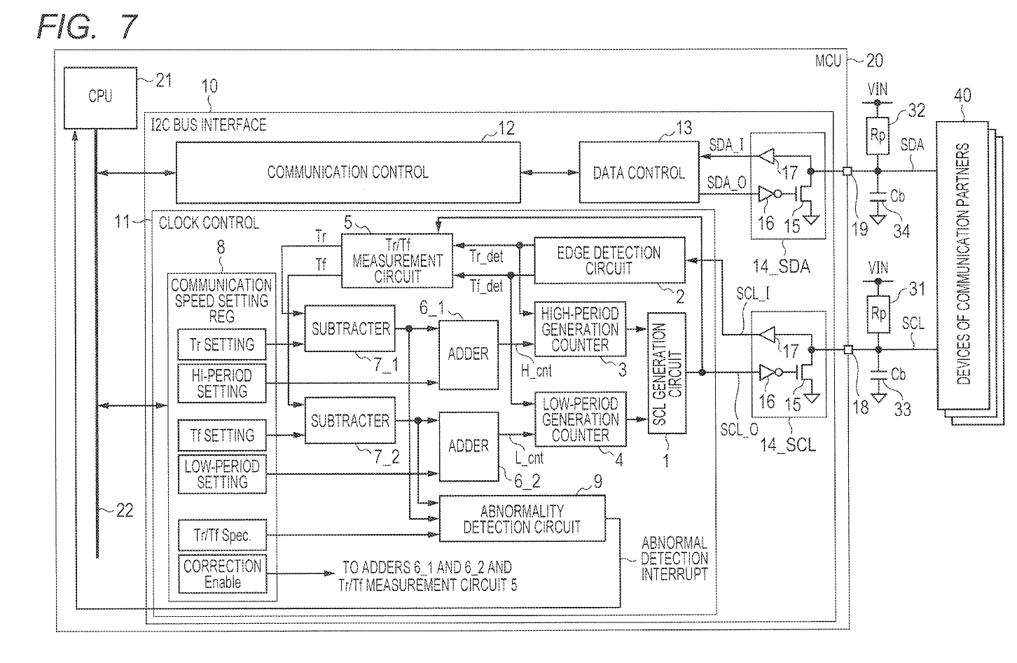

FIG. 7 is a block diagram illustrating a configuration example of the communication interface circuit 10 of a second embodiment. The communication interface circuit 10 of the second embodiment is different from the communication interface circuit 10 of the first embodiment illustrated in FIG. 2 with respect to the points that a rise time/fall time specification value (Tr/Tf spec.) can be also stored in the communication speed setting register 8 and an abnormality detection circuit 9 is further provided. Since the other configuration and operation are the same as the configuration of FIG. 2 and the operation of FIGS. 4 and 5 described in the first embodiment, the description will not be repeated.

To the abnormality detection circuit 9, the rise time/fall time specification value (Tr/Tf spec.) is supplied from the communication speed setting register 8, and the Tr correction value and the Tf correction value are input from the subtracters 7_1 and 7_2, respectively. When at least one of the Tr correction value and the Tf correction value lies out of the range specified by the rise time/fall time specification value (Tr/Tf spec.), the abnormality detection circuit 9 detects it as an abnormality, and makes an interrupt request to the CPU 21 by, for example, an abnormality detection interrupt signal to make a process handling the abnormality executed. When the correction value lies out of the assumed range, an abnormal situation is assumed rather than the case such that the load capacity largely actually fluctuates or the characteristic of the MOSFET 15 of the I/O buffer for SCL (14_SCL) largely fluctuates. The assumed abnormal situation is, for example, short-circuit or disconnection due to a foreign matter or the like of the clock line SCL, poor coupling of the pull-up resistor Rp 31, the MCU 20, and other devices of communication partners, a failure of the MOSFET 15 of the I/O buffer for SCL (14_SCL), or the like.

With such a configuration, the functions of a part of the correction circuit of the characteristics can be used also by a failure detection circuit. Consequently, the failure detection function can be provided with a smaller circuit scale.

The abnormality detection circuit 9 may be also configured, for example, to operate only in the calibration period. The problem of erroneously detecting, as abnormality, a normal operation by the cross stretch function or SCL synchronous function can be avoided. Alternatively, it is also possible to configure to maintain the operation of the abnormality detection circuit 9 as it is and mask or ignore an interrupt on the CPU 21 side.

Means of notifying the CPU 21 of an abnormality may be changed to a method other than an interrupt. For example, an abnormality detection status is stored in the communication speed setting register 8 and the CPU 21 monitors abnormality by polling or the like. For example, the CPU 21 may check the presence/absence of abnormality detection only when calibration is executed.

Although the correction is performed by the hardware on which the arithmetic circuit is actually mounted in the first and second embodiments, the configurations of the arithmetic circuits illustrated in FIGS. 2 and 7 are just an example and can be variously changed. For example, since the subtracters 7_1 and 7_2 do not execute computation at the same time and the adders 6_1 and 6_2 do not execute computation at the same time, one subtracter and one adder may be provided and operate in a time sharing manner. The high-period generation counter 3 and the low-period generation counter 4 may be also similarly configured. Although the example that the high-period setting value, the Tr setting value, the low-period setting value, and the Tf setting value can be stored in the communication speed setting register has been described, other parameters may be stored. For example, only the high period and the low period are set, and values obtained by subtracting measured Tr and Tf from the set high and low periods, respectively may be supplied as the high-count value H_cnt and the low-count value L_cnt to the high-period generation counter 3 and the low-period generation counter 4, respectively. In this case, the abnormality detection is changed to perform on the measured Tr/Tf.

### Third Embodiment

In the first and second embodiments, correction is performed by hardware. In a third embodiment, a mode of performing correction by software will be described.

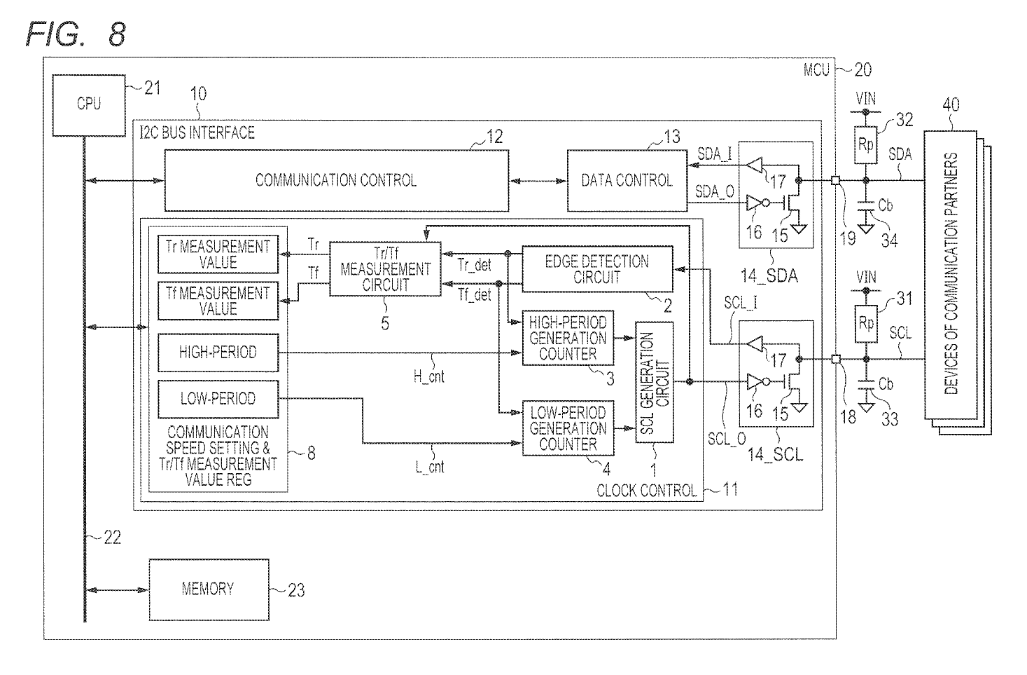

FIG. 8 is a block diagram illustrating a configuration example of the communication interface circuit 10 of the third embodiment. In the communication interface circuit 10 of the third embodiment, the subtracters 7_1 and 7_2 and the adders 6_1 and 6_2 mounted on the communication interface circuit 10 of the first embodiment illustrated in FIG. 2 are not mounted, and different parameters are stored in the communication speed setting register 8. In place of the high-period setting value, the low-period setting value, the rise time (Tr) setting value, the fall time (Tf) setting value, and the correction enable stored in the communication speed setting register 8 of the first embodiment, the high period (H_cnt) and the low period (L_cnt) can be written, and the Tr measurement value and the Tf measurement value as outputs of the rise/fall (Tr/Tf) measurement circuit 5 can be read.

To the internal bus 22 to which the communication interface circuit 10 is coupled, a memory 23 is coupled in addition to the CPU 21. By executing a program stored in the memory 23 by the CPU 21, the correcting process is performed. The memory may be, for example, a nonvolatile memory such as a flash ROM (Read Only Memory), a volatile memory such as a RAM (Random Access Memory), or a combination of those memories and, different from the memory illustrated in FIG. 8, may be also externally coupled.

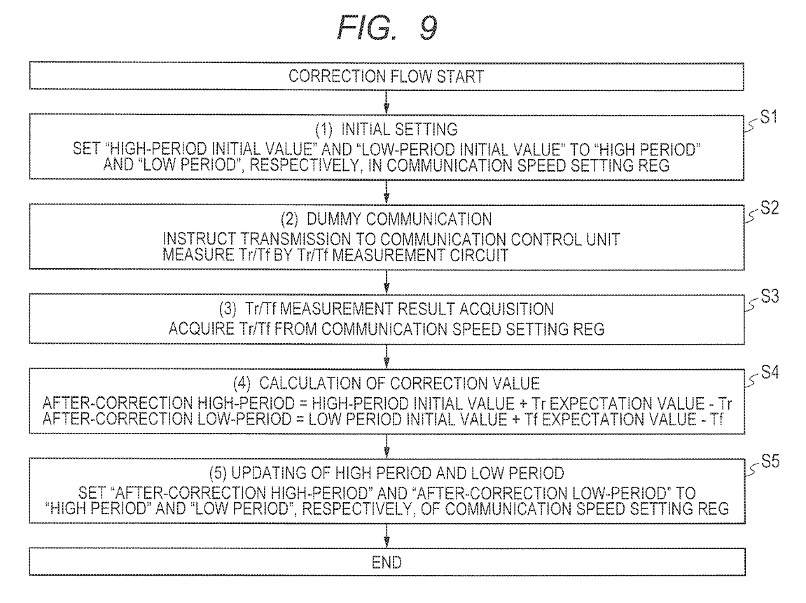

FIG. 9 is a flowchart illustrating an operation example of the correction by software in the communication interface circuit 10 of the third embodiment.

In first step (S1), initial setting is performed. A high-period initial value and a low-period initial value are set in the high period and the low period of the communication speed setting register 8, respectively. The user obtains expectation values (prediction values) of Tr and Tf by simulation or the like and performs the initial setting so that desired communication speed (cycle of the clock SCL) satisfies the following equation.

Cycle of SCL=high-period initial value+Tr expectation value+low-period initial value+Tf expectation value

In second step (S2), dummy communication is performed. Transmission of data is instructed from the CPU 21 to the communication control circuit 12 via the internal bus 22, and Tr/Tf is measured by the Tr/Tf measurement circuit 5. The Tr/Tf measurement result is written in the communication speed setting register 8.

In third step (S3), the Tr/Tf measurement result is obtained. The CPU 21 reads the Tr measurement value and the Tf measurement value measured by the Tr/Tf measurement circuit 5 from the communication speed setting register 8 via the internal bus 22.

In fourth step (S4), correction values of the high period and the low period are calculated. On the basis of the obtained Tr/Tf measurement results, the CPU 21 calculates values of the high period and the low period corrected by the following equations.

Corrected high period=high-period initial value+Tr expectation value−Tr measurement value

Corrected low period=low-period initial value+Tf expectation value−Tf measurement value

In fifth step (S5), the high period and the low period are updated. The CPU 21 writes the corrected high period and the corrected low period calculated in S4 into the communication speed setting register 8 via the internal bus 22.

By the above-described software process, the values of the high period and the low period of the communication speed setting register 8 are corrected on the basis of the rise time (Tr) and the fall time (Tf) actually measured, and the SCL cycle after correction becomes the value corresponding to a desired communication speed.

In such a manner, the communication speed correcting process can be performed by the software executed by the CPU 21. The CPU 21 executes the communication speed correcting process, for example, in a calibration period when the number of devices coupled to the communication bus increases/decreases by hot plugging immediately after power-on.

Although the invention achieved by the inventors of the present invention has been concretely described on the basis of the embodiments, obviously, the present invention is not limited to the embodiments but can be variously changed without departing from the gist.

For example, the basic part of the MCU made by the CPU, the memory, and the bus may be a processor of any architecture. The CPU may be any processor including a multiprocessor. Buses may be provided hierarchically. A cache memory and a memory control unit may be also provided. As described above, the memory may be a ROM, a RAM, or a combination of the ROM and the RAM, which is provided on-chip or externally.

For example, block division illustrated in the block diagrams is just an example. Changes such as a change of integrating part or all of the functions of one block with the functions of another block to thereby realize another block can be arbitrarily performed.

What is claimed is:

1. A communication interface circuit comprising:
a transistor which can pull down a clock line of a clock synchronous communication bus and drive it;
a clock signal generation circuit driving the transistor;
an edge detection circuit to which a signal level of the clock line is supplied and which detects each of a rising timing and a falling timing of the signal level;
a low-period generation counter counting a period of a low count value from the rising timing, setting the period as a low period, and controlling the clock signal generation circuit to pull-down drive the clock line by the transistor in the low period;
a high-period generation counter counting a period of a high count value from the falling timing, setting the period as a high period, and controlling the clock signal generation circuit to stop pull-down drive of the clock line by the transistor in the high period;
a fall measurement circuit obtaining fall time by measuring a period since start of the pull-down drive of the clock line by the transistor until the falling timing detected by the edge detection circuit, by the clock signal generation circuit; and
a rise measurement circuit obtaining rise time by measuring a period since stop of the pull-down drive of the clock line by the transistor until the rising timing detected by the edge detection circuit, by the clock signal generation circuit,
wherein the high period is adjusted on the basis of the rise time, and the low period is adjusted on the basis of the fall time.

2. The communication interface circuit according to claim 1, further comprising a rise-time setting register, a fall-time setting register, a high-period setting register, a low-period setting register, a first subtracter, a second subtracter, a first adder, and a second adder,
wherein the first subtracter supplies, as a rise-time correction value, the difference between a rise-time setting value which is set in the rise-time setting register and the rise time to the first adder, and the first adder adds the rise-time correction value to a high-period setting value which is set in the high-period setting register, thereby adjusting the high period, and supplies the resultant to the high-period generation counter, and
wherein the second subtracter supplies, as a fall-time correction value, the difference between a fall-time setting value which is set in the fall-time setting register and the fall time to the second adder, and the second adder adds the fall-time correction value to a low-period setting value which is set in the low-period setting register, thereby adjusting the low period, and supplies the resultant to the low-period generation counter.

3. The communication interface circuit according to claim 2, wherein when a correction enable signal is asserted, an output of the first adder is reflected in the high period, and an output of the second adder is reflected in the low period.

4. The communication interface circuit according to claim 3, further comprising:
a rise/fall time fluctuation allowable range register in which an allowable range of fluctuations of rise time and fall time can be set; and
an abnormality detection circuit,
wherein the abnormality detection circuit outputs an abnormality detection signal when at least one of the rise-time correction value and the fall-time correction value comes off an allowable range which is set in the rise/fall time fluctuation allowable range register.

5. A semiconductor integrated circuit comprising:
the communication interface circuit according to claim 3 further including a correction enable register supplying the correction enable signal;
a CPU; and
a bus,
wherein the CPU can access the rise-time setting register, the fall-time setting register, the high-period setting register, the low-period setting register, and the correction enable register via the bus.

6. A semiconductor integrated circuit comprising:
the communication interface circuit according to claim 4 further including a correction enable register supplying the correction enable signal;
a CPU; and
a bus,
wherein the CPU can access the rise-time setting register, the fall-time setting register, the high-period setting register, the low-period setting register, the rise/fall time fluctuation allowable range register, and the correction enable register via the bus, and the abnormality detection signal is input as an interrupt signal to the CPU.

7. A semiconductor integrated circuit according to claim 3, wherein the communication interface circuit further comprises: a data line drive circuit capable of pulling down and driving a data line of the clock synchronous communication bus; a data control circuit controlling the data line drive circuit; and a communication control circuit controlled by the CPU via the bus.

8. A semiconductor integrated circuit comprising:
the communication interface circuit according to claim 1;
a CPU; and
a bus,
wherein the communication interface circuit further comprises a rise-time register holding the rise time, a fall-time register holding the fall time, a high count register setting a held value as the high count value and supplying it to the high-period generation counter, and a low count register setting a held value as the low count value and supplying it to the low-period generation counter,
wherein the CPU can access the rise-time register, the fall-time register, the high-period setting register, and the low-period setting register via the bus, and
wherein in a communication speed correcting process executed in a calibration period, the CPU obtains the difference between a value of the rise time read from the rise-time register and a predetermined rise-time setting value, adds the difference to a predetermined high-period setting value, and writes the resultant value as the high count value into the high count register, and
obtains the difference between a value of the fall time read from the fall-time register and a predetermined fall-time setting value, adds the difference to a predetermined low-period setting value, and writes the resultant value as the low count value into the low count register.

9. A communication interface circuit comprising:
an input/output buffer driving a clock line of a clock synchronous communication bus and receiving a signal level of the clock line as an input clock signal; and
a clock control circuit to which the input clock signal is supplied,
wherein the clock control circuit generates an output clock signal which repeats a high level of a predetermined high period and a low level of a predetermined low period, drives the clock line by the input/output buffer,
measures, as rise time, time since the output clock signal is raised from the low level to the high level, after that, until rise of the signal of the clock line is detected by the rise of the input clock signal,
measures, as fall time, time since the output clock signal is decreased from the high level to the low level until the fall of the signal of the clock line according to the fall is detected by the fall of the input clock signal, and
corrects the high period and the low period on the basis of the measured rise time and the measured fall time, respectively.

10. The communication interface circuit according to claim 9,
wherein the clock control circuit has a communication speed setting register and an arithmetic circuit which can be accessed by a processor coupled,
wherein the communication speed setting register holds a rise-time assumption value, a fall-time assumption value, a high-period setting value, and a low-period setting value,
wherein the period of the high level and the period of the low level of the output clock signal are specified by the high-period setting value and the low-period setting value, respectively, and
wherein the arithmetic circuit updates the high-period setting value by adding the difference obtained by subtracting the rise time measured from the rise-time assumption value to the high-period setting value and updates the low-period setting value by adding the difference obtained by subtracting the fall time measured from the fall-time assumption value to the low-period setting value.

11. The communication interface circuit according to claim 10,
wherein the communication speed setting register further holds a correction enable control value,
wherein when correction is allowed by the correction enable control value, the arithmetic circuit executes updating of the high-period setting value and the low-period setting value, and
wherein when correction is inhibited by the correction enable control value, the high-period setting value and the low-period setting value are not updated but maintained in the communication speed setting register.

12. The communication interface circuit according to claim 10,
wherein the clock control circuit further comprises an abnormality detection circuit,
wherein the communication speed setting register further holds a rise/fall time fluctuation allowable range value indicating an allowable range of fluctuations of the rise time and the fall time, and
wherein when at least one of the rise-time correction value and the fall-time correction value comes off the allowable range set in the rise/fall time fluctuation allowable range register, the abnormality detection circuit outputs an abnormality detection signal.

13. A semiconductor integrated circuit comprising a processor, an input/output buffer, and a clock control circuit to which the input clock signal is supplied, and capable of performing communication using a clock synchronous communication bus which is coupled,
wherein the input/output buffer drives the clock line of the communication bus on the basis of an output clock signal which is input, receives the signal level of the clock line as an input clock signal, and supplies it to the clock control circuit,
wherein the clock control circuit has a register which can be accessed from the processor and can hold a high period, a low period, rise time, and fall time,
wherein the processor sets a high period and a low period in the register,
wherein the clock control circuit generates a clock which repeats to be at a high level of the high period and a low level of the low period set in the register, and outputs it as the output clock signal,
wherein the input/output buffer drives the clock line on the basis of the output clock signal, receives the signal level of the clock line accompanying the drive as the input clock signal, and supplies it to the clock control circuit,
wherein the clock control circuit measures, as rise time, time since the output clock signal is raised from the low level to the high level and rise of the signal of the clock line according to the rise is detected by the rise of the input clock signal, and stores it into the register,
wherein the clock control circuit measures, as fall time, time since the output clock signal is decreased from the high level to the low level and fall of the signal of the clock line according to the decrease is detected by the fall of the input clock signal, and stores it into the register, and
wherein the processor reads the rise time and the fall time measured, compares each of them with an expectation value thereby calculating a rise-time correction value and a fall-time correction value, corrects the high period and the low period on the basis of the rise-time correction value and the fall-time correction value, and writes the corrected high period and the corrected low period into the register.
